(19) United States
(12) Patent Application Publication
(10) Pub. No.: US 2015/0177062 A1
(43) Pub. Date: Jun. 25, 2015

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Tomohiro Nishiyama, Kawasaki-shi (JP)

(21) Appl. No.: 14/571,696

(22) Filed: Dec. 16, 2014

(30) Foreign Application Priority Data
Dec. 19, 2013 (JP) 2013-262756

(51) Int. Cl. G01J 1/42

(52) U.S. Cl. CPC G01J 1/4257

(57) ABSTRACT

An information processing apparatus includes an obtaining unit configured to obtain first beam information and second beam information. The first beam information indicates a direction and intensity of a first beam from an object as seen from a first viewpoint and defined by a first coordinate system; the second beam information indicates a direction and an intensity of a second beam from the object as seen from a second viewpoint which is different from the first viewpoint and defined by a second coordinate system which is different from the first coordinate system. A synthesizing unit is configured to synthesize the first beam information and the second beam information with each other after performing a coordinate transform of at least one of the first beam information and the second beam information.

### BACKGROUND OF THE INVENTION

1. Field of the Invention

The present invention relates to image processing by using beam information.

2. Description of the Related Art

A technology for obtaining information of a direction and an intensity of a beam of energy (light) from an object (light field data) by performing image pickup by using an optical system where a particular optical element is added to an optical system in a related art is proposed. In addition, a technology for adjusting a focus position (refocusing) of the picked-up image, a depth of field, or the like by image processing by using the light field data after the image pickup has been performed is proposed (Japanese Patent No. 4752031).

In addition, in an image pickup system in related art, a technique of performing projective transformation of images and stitching the images to each other to expand an angle of view is proposed (Japanese Patent No. 4324271).

Since an angle of view that can be picked up by a single camera at once is limited, to obtain light field data (LF data) across a large visual field as a single field, image pickup is to be performed plural times by a single camera, or plural pieces (sets) of LF data obtained by a plurality of cameras, are to be stitched to each other. However, although technology for stitching images to each other by using, for example, the technique like Japanese Patent No. 4324271 has been proposed, a technology for stitching plural pieces of light field data obtained from different points of view to each other is not well known or has not been specifically disclosed.

### SUMMARY OF THE INVENTION

Embodiments of the present invention disclose a technique to stitch plural pieces of light field data obtained from different scenes to each other. To that end, an information processing apparatus according to an aspect of the present invention includes:

an obtaining unit configured to obtain first beam information and second beam information, the first beam information indicating a direction and an intensity of a first beam from an object as seen from a first viewpoint and defined by a first coordinate system, and the second beam information indicating a direction and an intensity of a second beam from the object as seen from a second viewpoint different from the first viewpoint and defined by a second coordinate system different from the first coordinate system; and

a synthesizing unit configured to synthesize the first beam information and the second beam information with each other after performing a coordinate transform of at least one of the first beam information and the second beam information.

Further features of the present invention will become apparent from the following description of exemplary embodiments with reference to the attached drawings.

### BRIEF DESCRIPTION OF THE DRAWINGS

FIGS. 1A and 1B illustrate a configuration of a camera and an information processing unit according to a first exemplary embodiment.

FIGS. 2A and 2B illustrate a configuration of image pickup units.

FIG. 3 is an explanatory diagram for describing the LF coordinates.

FIGS. 4A and 4B illustrate a relationship between beams and LF coordinates.

FIG. 5 illustrates the LF data plotted on the LF coordinates.

FIGS. 6A and 6B illustrate a relationship between beams incident on different LF cameras and LF coordinates.

FIG. 7 is a flowchart illustrating a flow of processing performed in the information processing unit according to the first exemplary embodiment.

FIGS. 8A and 8B are explanatory diagrams for describing a concept of Radon transform.

FIG. 9 is an explanatory diagram for describing synthesis processing according to the first exemplary embodiment.

FIG. 10 is an explanatory diagram for describing a visual field boundary expansion according to the first exemplary embodiment.

FIGS. 11A to 11C are explanatory diagrams for describing image generation from the LF data.

FIG. 12 illustrates a configuration of the camera according to a second exemplary embodiment.

FIG. 13 is a flowchart illustrating a flow of processing performed in the information processing unit according to the second exemplary embodiment.

### DESCRIPTION OF THE EMBODIMENTS

### First Exemplary Embodiment

According to the present exemplary embodiment, descriptions will be given of a case where pieces of LF data obtained by a camera provided with a plurality of image pickup units that can obtain LF data are synthesized with each other.

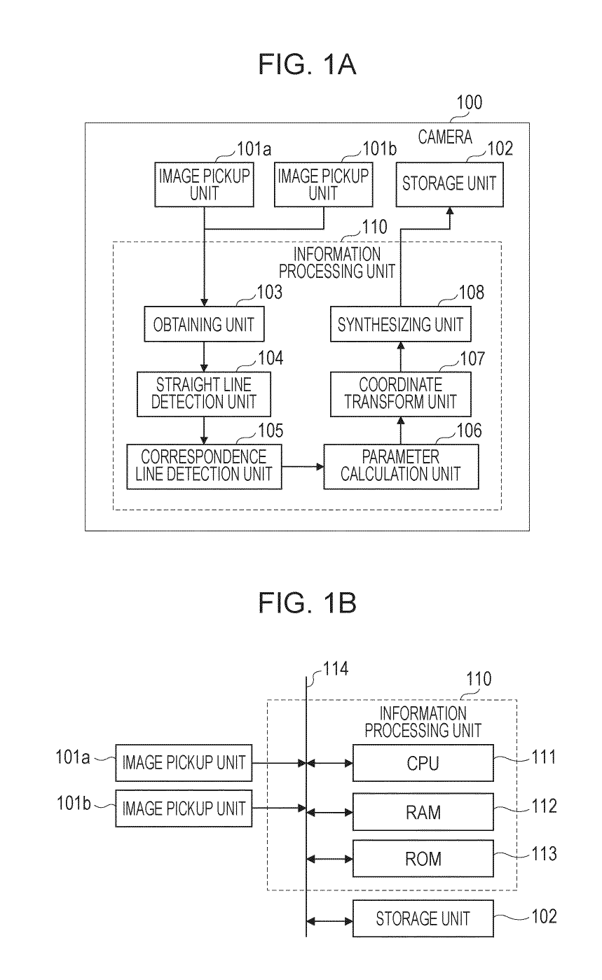

FIGS. 1A and 1B illustrate a configuration of a camera according to the present exemplary embodiment. A camera 100 according to the present exemplary embodiment is provided with image pickup units 101a and 101b, a storage unit 102, and an information processing unit 110. The information processing unit 110 includes an obtaining unit 103, a straight line detection unit 104, a correspondence line detection unit 105, a parameter calculation unit 106, a coordinate transform unit 107, and a synthesizing unit 108. Hereinafter, the respective components of the camera 100 will be described in turn.

The image pickup unit 101a and the image pickup unit 101b correspond to a camera unit constituted by a plurality of lenses, image pickup elements such as CMOS or CCD, and the like. The image pickup unit 101a and the image pickup unit 101b then obtain data indicating beam information on a direction and an intensity of beam incident from an object (hereinafter, may also be referred to as light field data or LF data). The respective image pickup units are detachably attached to a main body of the camera 100 and can perform image pickup in combinations of various viewpoints. Each of the respective image pickup units is a plenoptic camera having a micro lens array where a plurality of minute convex lenses are two-dimensionally arranged, between an image pickup lens and an image pickup element. It is noted that the image pickup unit 101a and the image pickup unit 101b are both the camera unit having the identical configuration, but any configuration may be employed so long as the LF data can be obtained. For example, the camera may be a multiple-lens camera including at least two camera units in which a plurality of camera units are arranged in a predetermined pattern. The configuration of the image pickup unit 101a will be described in detail below.

The storage unit 102 is a non-volatile storage medium such as a memory card or an HDD that can store the LF data obtained by the image pickup units 101a and 101b and the LF data synthesized by the information processing unit 110. For the storage unit 102, any storage medium may be used so long as the data can be stored, and an external storage apparatus connected via the Internet may also be used.

FIG. 1B illustrates a configuration of the information processing unit 110. The information processing unit 110 includes a CPU 111, a RAM 112, and a ROM 113, and a program stored in the ROM 113 is executed by the CPU 111 while the RAM 112 is used as a work area, so that roles as the respective units illustrated in FIG. 1A are realized. It is noted that the configuration of the information processing unit 110 is not limited to this, and the information processing unit 110 may also include a processing circuit having functions of the respective units illustrated in FIG. 1A. The outline of the configuration of the camera 100 according to the present exemplary embodiment has been described above. Next, the configuration and the role of the image pickup unit 101a and the image pickup unit 101b will be described in detail. Since the image pickup unit 101a and the image pickup unit 101b can have identical configuration, the present detailed description will be limited to the configuration of the image pickup unit 101a.

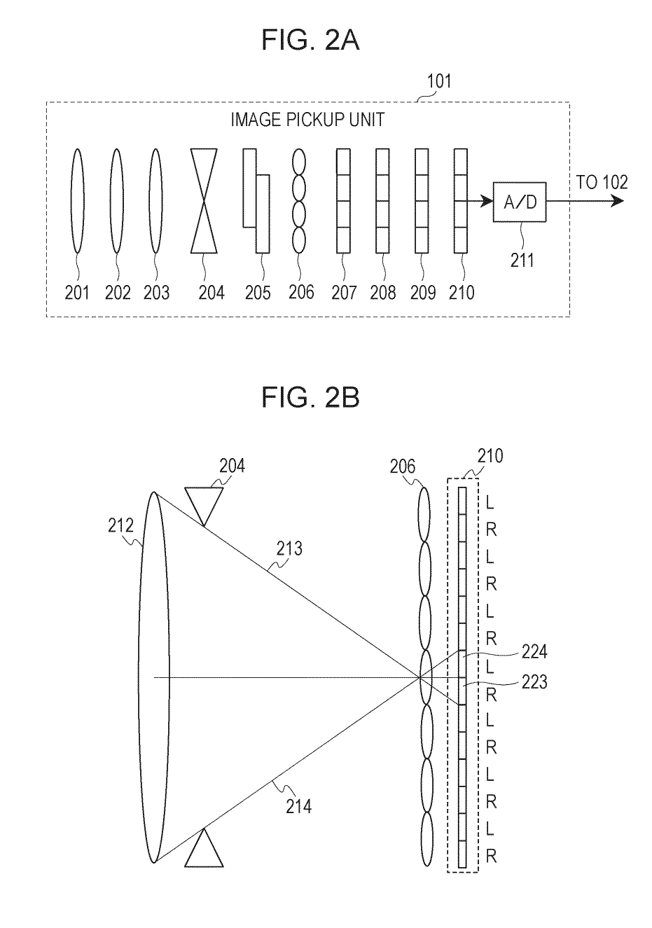

FIG. 2A illustrates an internal configuration of the image pickup unit 101a. The image pickup unit 101a is constituted by image pickup lenses 201, 202, and 203, an aperture stop 204, a shutter 205, a micro lens array 206, an optical low-pass filter 207, an IR (infrared) cut filter 208, a color filter 209, an image pickup element 210, and an analog-to-digital (A/D) transform circuit (unit) 211. The image pickup lenses 201 to 203 respectively correspond to the zoom lens 201 and the focus lenses 202 and 203. The quantity of energy (light) of the beam incident on the image pickup unit 101a and the depth of field of the image obtained by the image pickup unit 101a can be adjusted by adjusting the aperture stop 204 (hereinafter, simply referred to as aperture). The micro lens array 206 provided to obtain the LF data has a function of splitting the incident beam in accordance with its incident direction and is different from a focusing micro lens array that is not illustrated in the drawing and is arranged in a stage immediately before the image pickup element 210. In general, one lens is arranged for every pixel of the image pickup element in the focusing micro lens array, but one lens is arranged for every predetermined number of pixels (for example, one lens for every 16 pixels) in the micro lens array for obtaining the LF data. Each of the lenses in the micro lens array 206 for obtaining the LF data is referred to as micro lens irrespective of its size.

A method of obtaining the LF data by using the micro lens array 206 will be described by referring to FIG. 2B. As described above, the LF data refers to the data indicating the direction and the intensity of a beam of light reflected from the object being imaged and incident on the image pickup unit 101. In FIG. 2B, the zoom lens 201 and the focus lens 202 and 203 are collectively represented as a single main lens 212, and the micro lens array 206 is arranged on a focusing plane of the main lens 212. When the micro lens array 206 is arranged on the focusing plane of the main lens 212, lights focused by the micro lens array 206 are incident on different pixels in accordance with the incidence directions of the respective lights. For example, in FIG. 2B, although the lights are exited from the same object, beam 213 corresponding to the light that has passed through an upper half of the main lens 212 is incident on a pixel 223, and beam 214 corresponding to the light that has passed through a lower half of the main lens 212 is incident on a pixel 224.

In this manner, since the light that has passed through certain regions of the main lens are selectively incident on the respective pixels, an intensity of the incident light corresponding to the direction of the incident light can be obtained from a pixel value and a pixel position of the relevant pixel. A resolution of the direction of the incident light relies on the size of the micro lens included in the micro lens array. For example, in a case where one micro lens is provided for every 2×2=4 pixels, the direction of the beam can be resolved into four directions including the beam that passes through the upper left region of the main lens, the beam that passes through the upper right region, the beam that passes through the lower left region, and the beam that passes through the lower right region. Similarly, in a case where a micro lens is provided for every 4×4=16 pixels, the direction of the incident beam can be resolved into 16 directions. That is, in a case where the micro lens is small, it is difficult to increase the direction resolution of the beam. In view of the above, according to the present exemplary embodiment, processing of transforming LF data corresponding to sparse data into dense LF data is performed through interpolation processing such as linear interpolation. It is noted that the image pickup unit for obtaining the LF data is not limited to the plenoptic camera, and any configuration may be employed as long as beams incident from different directions can be differentiated from each other. For example, the camera may be a multiple-lens camera that includes a plurality of camera units and can perform simultaneous image pickup from different viewpoints.

### Definition of LF Coordinates

According to the present exemplary embodiment, the LF data obtained with regard to a plurality of scenes by the above-described image pickup units are synthesized with each other on light field coordinates (hereinafter, referred to as LF coordinates). Hereinafter, its principle will be described. First, a definition of the LF coordinates will be described.

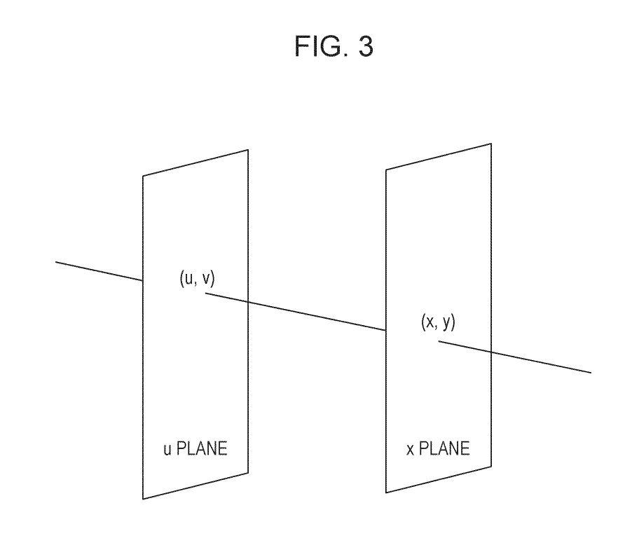

Since LF data refers to the data indicating the direction and the intensity of the beam, this is represented as a multi-dimensional vector having a plurality of scalar values respectively indicating the direction and the intensity of the beam incident. As illustrated in FIG. 3, a direction of a certain beam can be defined by coordinates of an intersecting point by the beam and two parallel planes intersected by the beam. When a first plane through which the beam passes is set as u plane, a second plane through which the beam passes is set as x plane, coordinates of an intersecting point by the beam and the u plane are set as (u, v), and coordinates of an intersecting point by the beam and the x plane are set as (x, y), the direction of the certain beam is represented as a vector (u, v, x, y). Since the LF data is composed of two pieces of data indicating the intensity corresponding to the certain single beam, when an intensity of the beam is set as L, the LF data is represented as L (u, v, x, y), that is, the intensity corresponding to each point in a four-dimensional space represented by a u axis, a v axis, an x axis, and a y axis. In view of the above, according to the present exemplary embodiment, the four-dimensional coordinates defined by the u axis, the v axis, the x axis, and the y axis is referred to as LF coordinates. It is noted that the representation of the LF coordinates is not limited to the above and can also be represented, for example, by an intersecting point (u, v) by the beam and the u plane and an exit angle (θ, φ) of the beam from the point (u, v).

### Appearance Manner on the LF Coordinates

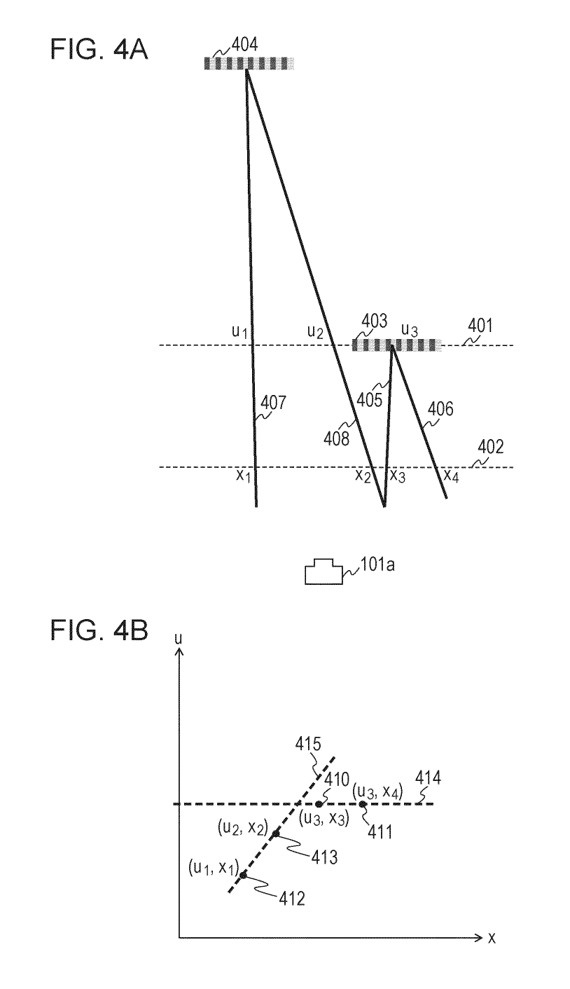

Next, a manner in which a set of beams exiting from a certain point of the object is mapped on the LF coordinates will be described by using FIGS. 4A and 4B. A plane 401 and a plane 402 are virtual planes parallel to each other which are virtually arranged in a three-dimensional space and are respectively referred to as u plane and x plane. The u plane 401 and the x plane 402 are originally the two-dimensional planes but are herein one-dimensionally represented for the convenience of drawing.

FIG. 4A illustrates a situation in which an object 403 and an object 404 are arranged in the three-dimensional space, and the image pickup unit 101a obtains the LF data of the space including the objects 403 and 404. Beams 405 and 406 are beams exiting from the object 403. When positions of the u plane 401 and the x plane 402 through which the beams pass are represented by a pair like (u, x), the beam 405 passes through (u₃, x₃), and the beam 406 passes through (u₃, x₄). When this is plotted on the LF coordinates where u is set as the vertical axis and x is set as the horizontal axis as illustrated in FIG. 4B, the positions are respectively plotted on points 410 and 411. That is, one beam corresponds to one point on the LF coordinates. Beams 407 and 408 are beams exiting from the object 404. The beam 407 passes through (u₁, x₁), and the beam 408 passes through (u₂, x₂). When this is plotted on the LF coordinates, the positions are respectively plotted on points 412 and 413.

As may be understood by observing FIG. 4B, all the points corresponding to each beam exiting from the certain point of the object are plotted on a single straight line on the LF coordinates. For example, the points corresponding to the beam exiting from the certain point of the object 403 are all plotted on a straight line 414, and the points corresponding to the beam exiting from the certain point of the object 404 are all plotted on a straight line 415. An inclination of the straight line where the points are plotted varies depending on a distance from the u plane 401 to the object. It is noted that, since the consideration herein has been given in terms of the LF coordinates in the two-dimensional space represented by reducing the respective numbers of dimensions of the u plane and the x plane by one each, all the beams exiting from the identical point are plotted on the single straight line. However, when the consideration has been given on this while the actual four-dimensional LF coordinates are employed, points corresponding to the beam exiting from the certain point of the object are all plotted one a single plane.

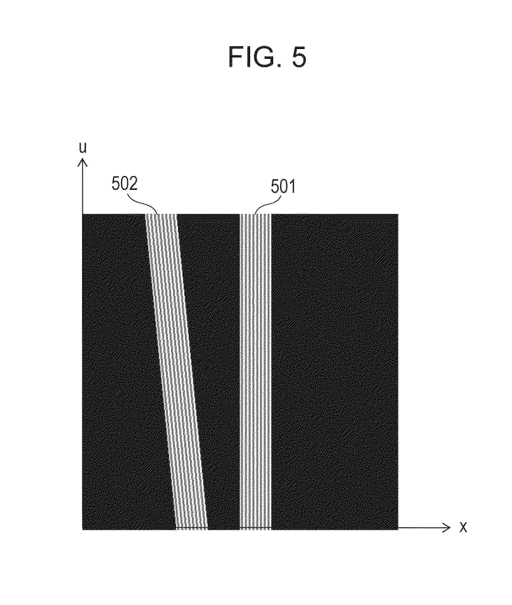

FIG. 5 represents which kind of LF data can be actually obtained in terms of the LF coordinates in the two-dimensional space. In the LF data illustrated in FIG. 5, the u plane is set as a main surface of the main lens 212, and the x plane is set as an image pickup sensor surface. A straight line group 501 on the right side of FIG. 5 is a straight line group corresponding to the object existing at a focus position of the image pickup unit 101a. Since the beams exiting from the object existing on a focusing plane of the image pickup unit 101a gather within a narrow range on the image pickup sensor irrespective of the passing points on the main lens 212, the beams are plotted on straight lines substantially parallel to the u axis of FIG. 5. A straight line group 502 on the left side of FIG. 5 is a straight line group corresponding to the object existing at a position slightly out of the focus position of the image pickup unit 101a. Since the beams exiting from the object existing at the position shifted from the focus position have shifted positions incident on the image pickup sensor depending on the passing points on the main lens 212, the beams accordingly draw straight lines having a larger inclination than the straight line group 501.

### Matching Between LF Data

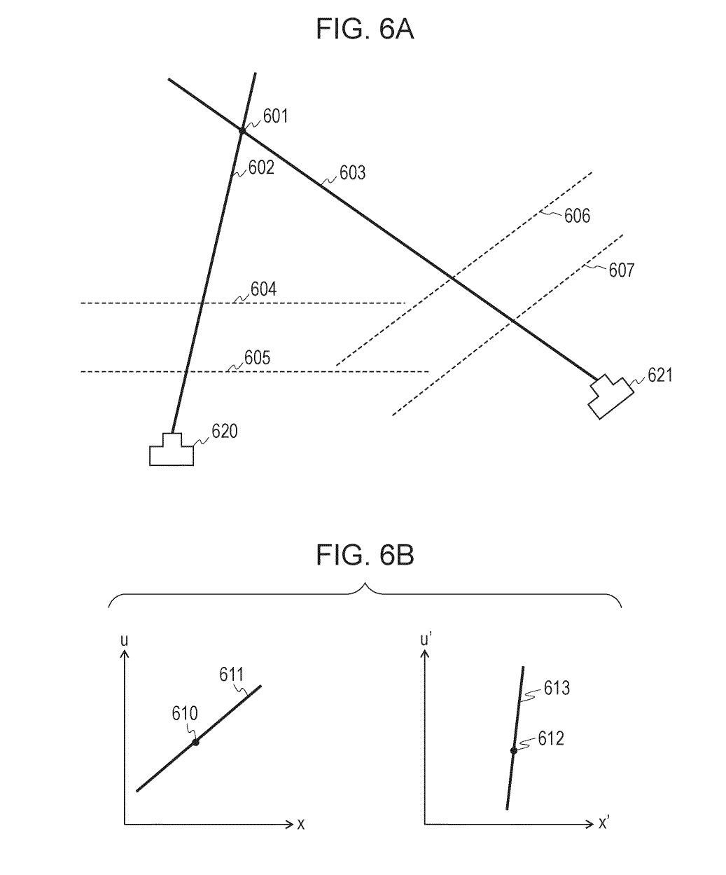

Next, descriptions will be given of a method of performing matching between two different pieces of LF data when the pieces of LF data obtained in different scenes which include an identical object are synthesized with each other. FIGS. 6A and 6B illustrate an example in which LF data is obtained by two light field cameras (LF cameras) having different viewpoint positions and directions with respect to a given object 601. FIG. 6A illustrates a manner in which beams exiting from a certain object 601 are incident on two different cameras 620 and 621. Beam 602 and beam 603 are beams exiting from an object 601, and the beam 602 passes through the u plane 604 and an x plane 605 which are parallel to an image pickup surface of an LF camera 620. The beam 603 passes through a u′ plane 606 and an x′ plane 607 which are parallel to an image pickup surface of an LF camera 621. FIG. 6B illustrates a situation in which each of these beams is plotted on the two-dimensional LF coordinates.

In FIG. 6B, a point 610 is obtained by plotting the beam 602 on the basis of the coordinates of the passing points on the u plane 604 and the x plane 605, and a point 612 is obtained by plotting the beam 603 on the basis of the coordinates of the passing points on the u′ plane 606 and the x′ plane 607. In FIG. 6B, a straight line 611 is obtained by plotting all the beams exiting from the object 601 on the ux plane corresponding to the LF coordinates of the LF camera 620. On the other hand, a straight line 612 is obtained by plotting all the beams exiting from the object 601 on the u′x′ plane corresponding to the LF coordinates of the LF camera 621. In this manner, the straight line 611 and the straight line 613 described above are straight lines which are respectively represented by the different coordinate systems but both correspond to the same object. That is, to synthesize the LF data obtained in the different scenes with each other, the corresponding straight lines like the straight line 611 and the straight line 613 may be detected on the respective LF coordinates, and coordinate transform of one of the two pieces of LF data may be performed so as to be overlapped with each other. Here again, since the actual matching is performed between the LF data represented in the four-dimensional space, the coordinate transform is performed such that the corresponding planes are overlapped with each other in the actual transform. However, even in a case where the coordinate transform is performed while the focus is only on the straight lines instead of the planes, if the parameter for the coordinate transform is calculated such that plural sets of the corresponding straight lines are overlapped with each other, it is possible to perform coordinate transform similar to the case where the coordinate transform is performed such that the planes are overlapped with each other. In view of the above, according to the present exemplary embodiment, by using the latter method, the coordinate transform is performed such that the straight line on the ux plane and the straight line on the u′x′ plane corresponding to the same object are overlapped with each other.

### Processing Detail

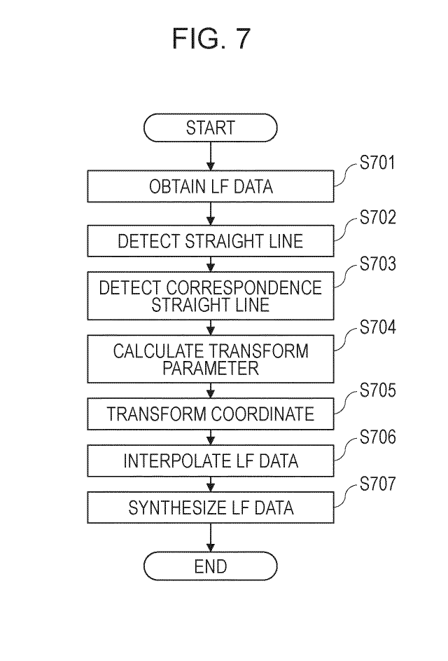

The outline of the LF data synthesis processing performed by the camera 100 according to the present exemplary embodiment has been described above. Hereinafter, processing performed by the information processing unit 110 according to the present exemplary embodiment will be described in detail with reference to the flowchart illustrated in FIG. 7. The ROM 113 according to the present exemplary embodiment stores a program (algorithm) illustrated in the flowchart of FIG. 7, and the information processing unit 110 performs processing in the following steps when the CPU 111 executes the program.

In S701, the obtaining unit 103 obtains the LF data obtained by the respective image pickup units from the image pickup units 101a and 101b. The LF data obtained by the image pickup unit 101a is set as LF data A, and the LF data obtained by the image pickup unit 101b is set as LF data B. The obtaining unit 103 outputs the LF data A and the LF data B obtained at this time to the straight line detection unit 104.

In S702, the straight line detection unit 104 detects straight lines existing in the respective LF data with regard to the LF data A and the LF data B output from the obtaining unit 103. At this time, the ux plane where y and v are fixed is used as the plane where the straight line is detected. It is noted that the straight line may also be detected on the yv plane where x and u are fixed. Hereinafter, a straight line detection method according to the present exemplary embodiment will be described.

Radon transform is used in the straight line detection according to the present exemplary embodiment. The Radon transform on the ux plane is defined by the following expression.

R(θ,X)=∫_{-∞}^{∞}(X cos θ−U sin θ,X sin θ+U cos θ)dU (1)

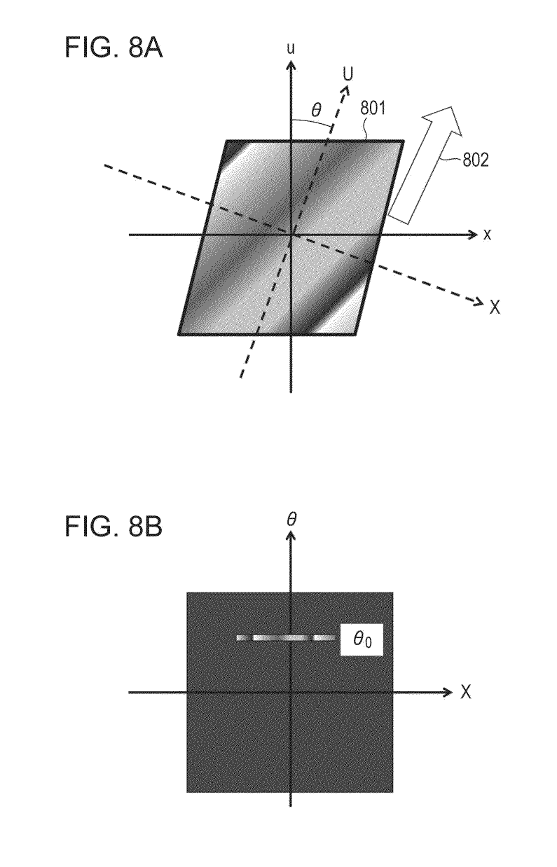

FIGS. 8A and 8B are conceptual diagrams of the Radon transform. FIG. 8A illustrates a situation in which the Radon transform of the LF data 801 is performed. An arrow 802 represents a direction where integration is performed, and a coordinate axis UX is obtained by rotating a coordinate axis ux by a rotation angle θ. In the Radon transform, the coordinate axis UX is rotated by changing the rotation angle θ, and next, a value of L is integrated in a U direction. FIG. 8B is a conception diagram in which the Radon transform of the LF data 801 is performed on the basis of Expression (1). Since the LF data 801 includes the straight line, a peak appears in the position at an inclination θ₀ equivalent to the straight line, and smaller values appear in the other positions. An inclination and an intercept of the detected straight line can be obtained on the basis of the position on the xθ plane at this peak. In this step, the straight line detection unit 104 detects the peak from a function of a result where L(u, x) corresponding to the LF data A and L(u′, x′) corresponding to the LF data B are assigned to Expression (1) to perform the Radon transform as f(u, x) in Expression (1). Subsequently, the inclination and the intercept of the straight line corresponding to the peak are calculated from the position of the detected peak, and the calculated inclination and intercept as well as an average intensity of points mapped on the detected straight line are output to the correspondence line detection unit 105. It is noted that a technology in a related art can be used for the peak detection, and according to the present exemplary embodiment, the LF data on which to the Radon transform has been performed is differentiated by θ and X, and a point where a sign of the differentiated value is inverted is detected as the peak.

In S703, the correspondence line detection unit 105 detects the corresponding straight line on the basis of the intensity of the straight line output from the straight line detection unit 104. Since L according to the present exemplary embodiment is obtained by the camera that can pick up a color image, three pixel values of R, G, and B are prepared. A differential square sum is taken from the three pixel values corresponding to the straight line detected in each of the LF data A and the LF data B with each other, and a set of the straight lines where the value becomes lowest are detected as the straight lines. The values to be compared are not limited to the three pixel values. Components corresponding to the luminance of the image may be used, or the corresponding straight line may be decided on the basis of a degree of similarity of the pattern drawn on the LF data on which to the Radon transform has been performed.

In S704, the parameter calculation unit 106 calculates a transform parameter for performing the coordinate transform of the LF data A and the LF data B on the basis of the expression of the corresponding straight line output from the correspondence line detection unit 105. Hereinafter, the calculation method will be described.

In FIG. 6A, camera coordinates of the object 601 in the LF camera 620 are set as (X_{obj}, Y_{obj}, Z_{obj}), and a distance between and the u plane 604 and the x plane 605 is set as d. Herein, in the camera coordinates, an origin is set on the x plane 605, an optical axis of the camera is set as the z axis, and the x and y axes are set in a plane perpendicular to the z axis. In the normal camera coordinates, a principal point of the camera is set as the origin, but for the convenience of calculation to be carried out later, the origin is set on the x plane 605 herein. d is an already found amount. As α=Z_{obj}/d, when a point where the object exists is set as a point A, and intersecting points by the beam 602 and the u plane 604 and the x plane 605 are respectively set as a point B (u, v) and a point C (x, y), the following relationship is established among the respective coordinates since the point A is a point externally dividing a segment BC into 1:α−1.

$$( \begin{matrix}{X}_{obj} \\ {Y}_{obj}\end{matrix} ) = ( 1 - α ) ( \begin{matrix}x \\ y\end{matrix} ) + α ( \begin{matrix}u \\ v\end{matrix} ) \qquad ( 2 )$$

This corresponds to the straight line 611. When the inclination and the intersect of the straight line 611 on the LF coordinates are assigned to Expression (2) for calculation, it is possible to obtain α, X_{obj}, and Y_{obj}. Herein, since d is already found, it is possible to obtain the camera coordinates of the object (X_{obj}, Y_{obj}, Z_{obj}) on the basis of α=Z_{obj}/d. In addition, by performing the similar calculation for the LF data obtained by the LF camera 621, it is also possible to obtain the camera coordinates (X′_{obj}, Y′_{obj}, Z′_{obj}) of the object 601 as observed from the LF camera 621.

When a rotation vector representing a relation between the camera coordinates of the respective LF cameras is denoted by R, and a translation vector is denoted by t, the transform for combining the camera coordinates of the LF cameras 620 and 621 with each other is represented by the following expression.

X′_{obj}=RX_{obj}+t (3)

Herein, X_{obj} and X′_{obj} in bold are vectors indicating the camera coordinates of the object respectively observed from the LF cameras 620 and 621. In Expression (3), the number of independent parameters of the rotation vector is 3, and the number of independent parameters of the translation vector is also 3. Since the number of unknown values is 6, if 6 or more of equations exist, the respective parameters can be obtained. Since Expression (3) includes 3 independent equations, if 2 or more sets of the corresponding objects are obtained, it is possible to establish 3×2=6 equations, and the rotation vector R and the translation vector t can be obtained.

The method of calculating the transform parameter for the coordinate transform has been described above. In this step, the LF camera 620 described above is replaced by the image pickup unit 101a, the LF camera 621 is replaced by the image pickup unit 101b, and the parameter calculation unit 106 assigns the inclination and the intersect of the corresponding straight line output from the corresponding line detection unit to Expression (2) to calculate the plurality of coordinates of the object. Subsequently, the calculated coordinates of the object are assigned to Expression (3) to obtain the rotation vector R and the translation vector t, and the obtained R and t are output to the coordinate transform unit 107.

In S705, the coordinate transform unit 107 performs the coordinate transform of the LF data A on the basis of the information indicating the rotation vector R and the translation vector t output from the parameter calculation unit 106. Hereinafter, the method will be described. In FIG. 6A, an equation in the camera coordinates of the LF camera 620 of the beam 602 that passes through the u plane 604 (u, v) and the x plane 605 (x, y) can be represented by the following expression. In the following expression, (X, Y, Z) indicate camera coordinates of an arbitrary point on the beam 602.

$$( \begin{matrix}X \\ Y \\ Z\end{matrix} ) = s ( \begin{matrix}u - x \\ v - y \\ d\end{matrix} ) + ( \begin{matrix}x \\ y \\ 0\end{matrix} ) \qquad ( 4 )$$

Where s is an appropriate variable. Camera coordinates of an arbitrary point on the beam 603 are set as (X′, Y′, Z′) from the positional relationship between the LF camera 620 and the LF camera 621, and an equation in the camera coordinates of the beam 603 can be represented by the following expression by using the rotation vector R and the translation vector t.

$$( \begin{matrix}{X}^{′} \\ {Y}^{′} \\ {Z}^{′}\end{matrix} ) = sR ( \begin{matrix}u - x \\ v - y \\ d\end{matrix} ) + R ( \begin{matrix}x \\ y \\ 0\end{matrix} ) + t \qquad ( 5 )$$

To plot the beam 602 on the LF coordinates of the LF camera 621, intersecting points by the beam 602 and the u′ plane 606 and the x′ plane 607 may be obtained. Since the u′ plane 606 exists where Z′=d, the intersecting point by the beam 602 and the u′ plane 606 can be obtained by setting Z′=d. s at that time can be derived from the equation of a z component in Expression (5).

$${s}_{u} = \frac{d - {( R ( \begin{matrix}x \\ y \\ 0\end{matrix} ) )}_{3} - {t}_{3}}{{( R ( \begin{matrix}u - x \\ v - y \\ d\end{matrix} ) )}_{3}} \qquad ( 6 )$$

Where a subscript “3” represents the z component of the vector. When sᵤ obtained in Expression (6) is assigned to Expression (5), it is possible to obtain the coordinates (u′, v′) corresponding to the intersecting point by the beam 602 and the u′ plane 606.

$$( \begin{matrix}{u}^{′} \\ {v}^{′} \\ d\end{matrix} ) = {s}_{u} R ( \begin{matrix}u - x \\ v - y \\ d\end{matrix} ) + R ( \begin{matrix}x \\ y \\ 0\end{matrix} ) + t \qquad ( 7 )$$

On the other hand, since the x′ plane 607 exists where Z′=0 in the above-described expression, the intersecting point by the beam 602 and the x′ plane can be obtained by setting Z′=0. Similarly as in the case where the intersecting point with the u′ plane, the value of s can be derived.

$${s}_{x} = \frac{- {( R ( \begin{matrix}x \\ y \\ 0\end{matrix} ) )}_{3} - {t}_{3}}{{( R ( \begin{matrix}u - x \\ v - y \\ d\end{matrix} ) )}_{3}} \qquad ( 8 )$$

Subsequently, when sx obtained in Expression (8) is assigned to Expression (7), it is possible to obtain the coordinates (x′, y′) corresponding to the intersecting point by the beam 602 and the x′ plane 607.

$$( \begin{matrix}{x}^{′} \\ {y}^{′} \\ 0\end{matrix} ) = {s}_{x} R ( \begin{matrix}u - x \\ v - y \\ d\end{matrix} ) + R ( \begin{matrix}x \\ y \\ 0\end{matrix} ) + t \qquad ( 9 )$$

When the above-described Expressions (8) and (9) are used, it is possible to transform the LF data A from the coordinate system (u, v, x, y) to the coordinate system of the LF data B (u′, v′, x′, y′). In this step, the coordinate transform unit 107 assigns the coordinates (u, v, x, y) of the respective components of the LF data A and R and t output from the parameter calculation unit 106 to Expressions (6) to (9), and LF data C corresponding to the LF data after the coordinate transform is obtained.

In S706, the coordinate transform unit 107 adjusts a sampling interval of the LF data C obtained in S705 by interpolation processing. According to the present exemplary embodiment, the LF data A and the LF data B are obtained at a sampling interval A on the respective LF coordinates. For that reason, the respective sampling points are regularly aligned at a constant interval. However, in a case where the above-described coordinate transform is performed, in general, the sampling points after the coordinate transform are transformed into positions that are not in conformity to the above-described rule. In view of the above, in this step, the coordinate transform unit 107 performs correction such that the respective sampling points of the LF data C are to follow intervals of sampling points of the LF data B. Specifically, when a point in conformity to the sampling rule of the LF data B is referred to as grid point, in a case where the intensity value L is not stored in a certain grid point in the LF data C after the coordinate transform, linear interpolation of the value L is performed on the basis of a location and an intensity value of a surrounding point where the intensity value L is stored. When the coordinates of the point set as the interpolation target are set as (u_{c}, v_{c}, x_{c}, y_{c}), and the coordinates of the surrounding point used for the interpolation are set as (uₛ, vₛ, xₛ, yₛ), the surrounding point used for the interpolation corresponds to a point that satisfies all the following relationships.

u_{c}−Δ<uₛ<u_{c}+Δ

v_{c}−Δ<vₛ<v_{c}+Δ

x_{c}−Δ<xₛ<x_{c}+Δ

y_{c}−Δ<yₛ<y_{c}+Δ (10)

When the interpolation of all the grid points is completed, data of points other than the grid points is deleted. The coordinate transform unit 107 adjusts the sampling interval of the LF data C on the basis of the above-described relationship and outputs the LF data C′ where the adjustment of the sampling interval is completed to the synthesizing unit 108. The interpolation performed herein is not limited to the linear interpolation, and various interpolation processings can be employed. In addition, although the data of the points other than the grid points is deleted herein, the data of the points other than the grid points may be held without deletion.

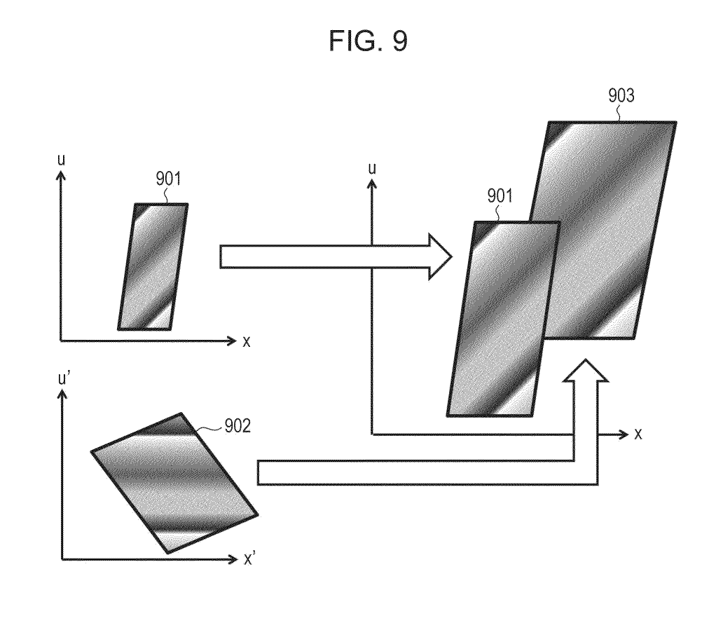

In S707, the synthesizing unit 108 synthesizes the LF data B with the LF data C′ to be output to the storage unit 102 and ends the processing. An outline of the synthesis processing herein is illustrated in FIG. 9. In FIG. 9, the LF data 901 corresponding to the LF data B and the LF data 902 corresponding to the LF data C are synthesized with each other. At this time, the coordinate transform of the LF data 902 is performed as the LF data 903 corresponding to the LF data C′ to be synthesized with the LF data 901. With this configuration, the straight lines corresponding to the same object are synthesized to be overlapped with each other, and it is possible to perform the stitching of the light fields obtained in the two scenes. In the synthesis, with regard to a region where the two pieces of LF data are overlapped with each other, the value of the LF data B which is not the value generated by the interpolation is prioritized. It is noted that, of course, the value L of the overlapped region may be obtained as an average of the value L of the LF data B and the value L of the LF data C′.

According to the present exemplary embodiment, the obtaining units 103 respectively correspond to a plurality of different viewpoint positions and function as obtaining units configured to obtain plural pieces of beam information each indicating the direction and the intensity of the beam incident from the object on the corresponding viewpoint position, which correspond to the beam information including the information related to the same object. The coordinate transform unit 107 and the synthesizing unit 108 function as a synthesizing unit configured to perform the coordinate transform of at least one of the plural pieces of beam information and synthesize the plural pieces of beam information with each other. The parameter calculation unit 106 functions as a derivation unit configured to derive a transform parameter used in the coordinate transform. The correspondence line detection unit 105 functions as a specifying unit configured to specify information corresponding to the identical object between first beam information and second beam information.

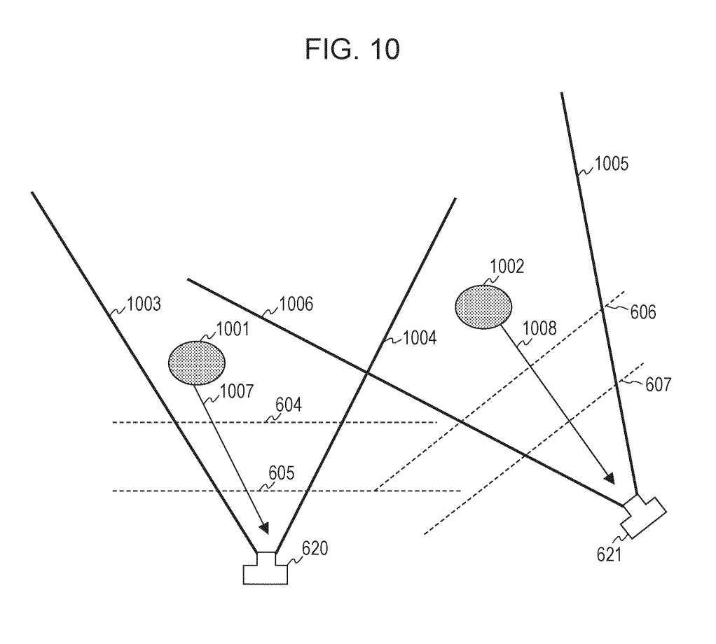

The processing performed by the information processing unit 110 according to the present exemplary embodiment has been described above. According to the above-described processing, it is possible to stitch the LF data obtained in the plurality of different scenes to each other. For example, considerations will be given of a case illustrated in FIG. 10. In FIG. 10, the LF camera 620 has a viewing angle range surrounded by straight lines 1003 and 1004, and it is possible to obtain information of a direction and an intensity of beam towards the LF camera 620 within the viewing angle range. Similarly, the LF camera 621 has a viewing angle range surrounded by straight lines 1005 and 1006, and it is possible to obtain information of a direction and an intensity of beam towards the LF camera 621 within the viewing angle range. Since an object 1001 normally exists out of the viewing angle range of the LF camera 621, the LF camera 621 does not obtain information of beam 1007 exiting from the object 1001. However, when the present invention is applied to the configuration, the information of the beam 1007 can be mapped on the LF coordinates of the LF camera 621. In addition, similarly, when the present invention is applied to the configuration, information of beam 1008 exiting from an object 1002 can be mapped on the LF coordinates of the LF camera 620. In this manner, according to the present invention, since the LF data obtained in the plurality of scenes can be all treated in the identical coordinate system, the image processing using the LF data such as refocus can be performed over a wide range in a unified manner.

### Second Exemplary Embodiment

According to the first exemplary embodiment, the technology for stitching the LF data to each other has been described. According to the present exemplary embodiment, processing of generating a refocus image by using the LF data obtained by the stitching will be described. First, a principle for generating the refocus image from the LF data will be described.

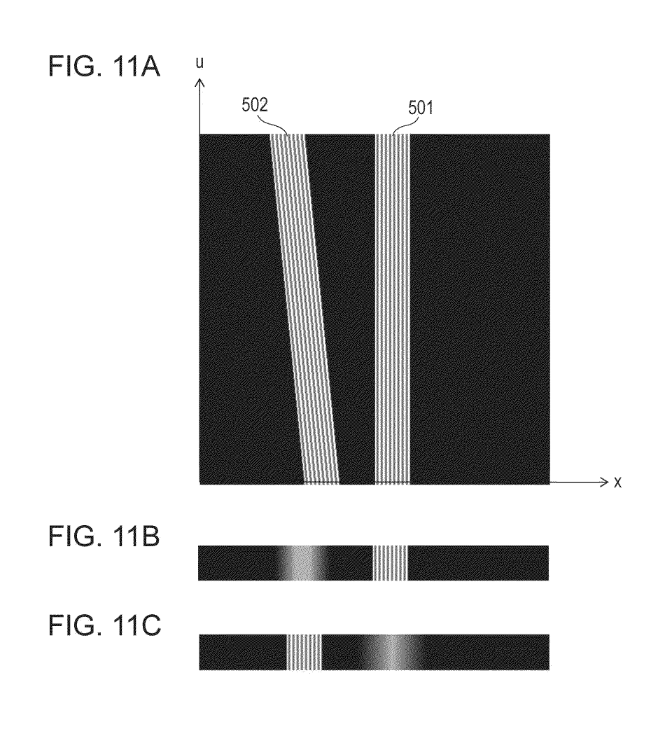

The LF data defined in the LF coordinates can be transformed into image data picked up by the normal camera. The image data picked up by the normal camera is composed of a data group in which scalar values (pixel values I) correspond to the respective points (x, y) in the two-dimensional plane. Since the LF data is formally obtained from the pixel value of the image pickup sensor, the data can be transformed into I (x, y) by integrating the LF data represented by L (u, v, x, y) in the u direction and the v direction. According to the integration method at this time, it is possible to freely change the focusing state of the image data such as the focus position or the depth of field. FIGS. 11A to 11C illustrate an example thereof. FIG. 11A is the same drawing as FIG. 5, illustrating the LF data obtained while the main surface of the main lens 212 is set as the u plane, and the image pickup sensor surface is set as the x plane. As described above, the originally four-dimensional LF coordinates are reduced into two dimensions to be illustrated. FIG. 11B and FIG. 11C respectively illustrate an image obtained by integrating FIG. 11A in the direction of the straight line group 501 and an image obtained by integrating FIG. 11A in the direction of the straight line group 502. It is noted that the images illustrated herein are originally one-dimensional images, but for the sake of illustration, the images have a width in an up and down direction.

In FIG. 11B where the image is obtained by performing the integration in the direction of the straight line group 501, the object corresponding to the straight line group 501 comes into focus, and the object corresponding to the straight line group 502 is displayed in a blurred manner. On the other hand, in FIG. 11C where the image is obtained by performing the integration in the direction of the straight line group 502, the object corresponding to the straight line group 502 comes into focus, and the object corresponding to the straight line group 501 is displayed in a blurred manner. In this manner, by performing the integration in the direction of the straight line (plane in the four-dimensional LF coordinates) corresponding to the object to be focused, it is possible to obtain the image in which the desired object comes into focus. In addition, depending on the extent of the integration range at this time, the depth of field of the image can also be changed. For example, when the integration range is expanded, since the image formed by the beam that has passed through the wide range is obtained, the image in which the depth of field is shallow as picked up by the camera having a large opening is obtained. On the other hand, when the integration range is narrowed, since the image formed by the beam that has passed through the narrow range is obtained, the image in which the depth of field is deep as picked up by the camera having a small opening is obtained.

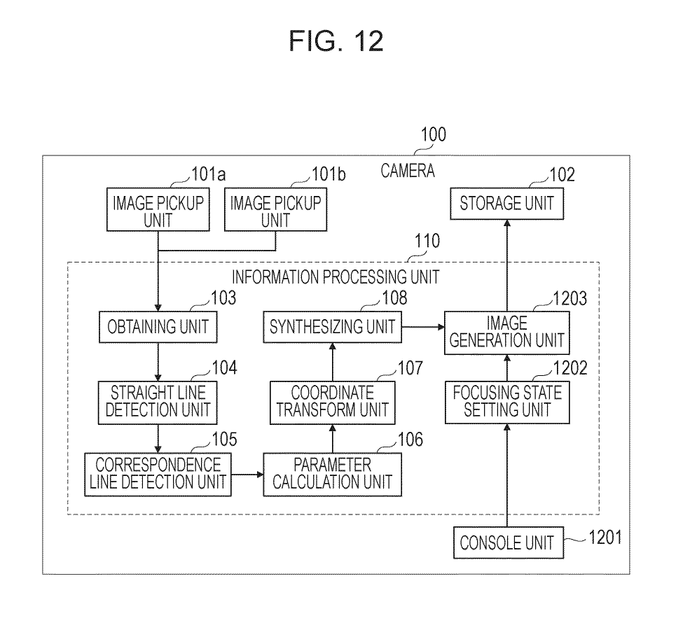

The principle for generating the refocus image from the LF data has been described above. Next, a configuration of the camera 100 according to the present exemplary embodiment will be described. FIG. 12 is a block diagram of the configuration of the camera 100 according to the present exemplary embodiment. The camera 100 according to the present exemplary embodiment is newly provided with a console unit 1201 in addition to the configuration according to the first exemplary embodiment, and the information processing unit 110 newly has functions as a focusing state setting unit 1202 and an image generation unit 1203. The console unit 1201 is a touch panel superimposed on a display unit (not illustrated) of the camera 100, and it is possible to set the focus position or the depth of field in the refocus processing by touch operation performed by a user. A mode of the console unit 1201 is not limited to the touch panel, and any configuration may be employed such as a button or a mode dial so long as the instruction of the user can be input.

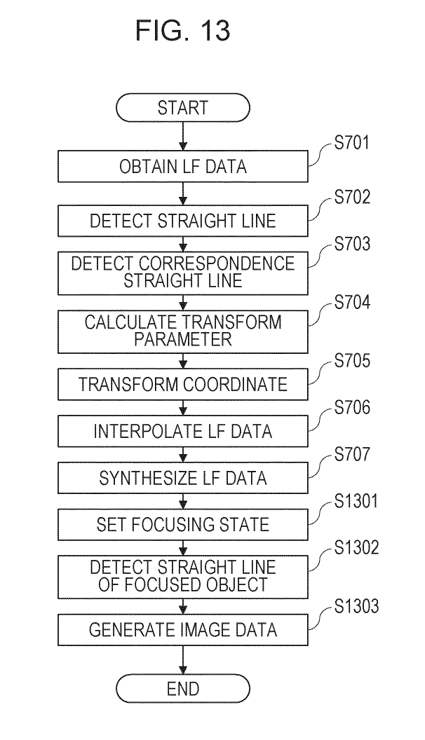

Hereinafter, processing performed in the camera 100 according to the present exemplary embodiment will be described with reference to a flowchart illustrated in FIG. 13. The ROM 113 according to the present exemplary embodiment stores a program illustrated in the flowchart of FIG. 13, and the information processing unit 110 performs processing in the following steps when the CPU 111 executes the program. It is noted that the same processing as the first exemplary embodiment will be assigned with the same reference symbol, and the description thereof will be omitted.

In S1301, the focusing state setting unit 1202 sets a focusing state of image data to be generated on the basis of a user instruction input by operation of the console unit 1201 and outputs the set focusing state to the image generation unit 1203. In this step, the setting is performed while the user observes an image displayed on the display unit and touches an object desired to be focused. The focusing state setting unit 1202 detects a pixel position corresponding to the object to be focused on the basis of a point touched in the console unit 1201 and outputs the pixel position to the image generation unit 1203. The image displayed herein on the display unit when the user sets the focusing state may be obtained by simply arranging images picked up by the image pickup unit 101a and the image pickup unit 101b or may be a pan focus image generated from the synthesized LF data. The pan focus image can be generated by extracting a certain single xy plane in the synthesized LF data. Herein, the user may also select a radius of a virtual aperture to perform the setting of the depth of field. Instead of the pixel position of the object, a distance to the object to be focused or the like may be set in figures by the user, and the set information may be output to the image generation unit 1203.

In S1302, the image generation unit 1203 obtains an inclination of the straight line corresponding to the object to be focused on the basis of the focusing state output from the focusing state setting unit 1202. In this step, the image generation unit 1203 detects the straight line corresponding to the object to be focused on the basis of the pixel position of the object output from the focusing state setting unit 1202. When the pixel position of the object to be focused is set as (xₚ, yₚ), the image generation unit 1203 detects the straight line intersecting with the straight line x=xₚ as the straight line corresponding to the object to be focused on the ux plane where y=yₚ is fixed. It is noted that in a case where a plurality of straight lines intersect with x=xₚ, the straight line having a value of the u coordinate of the intersecting point closer to the center of the drawing range in the u axis is detected as the straight line corresponding to the object to be focused. Accordingly, in a case where the focused object in the image observed from the center viewpoint of the camera is selected, the desired object is more accurately selected. The image generation unit 1203 performs the Radon transform of the LF data on the ux plane where y=yp is fixed and obtains an inclination of the detected corresponding straight line. As the detection method for the corresponding straight line used herein, other methods may be employed.

In S1303, the image generation unit 1203 performs the integration of the LF data on the basis of the inclination obtained in S1302 and generates refocus image data.

In FIGS. 4A and 4B, when the z coordinate of the x plane 402 is set as 0, the z coordinate of the u plane 401 is set as d, and the z coordinate of the plane desired to be focused is set as dₚᵢₙₜ, as described in the first exemplary embodiment, beams exiting from a point existing on z=dₚᵢₙₜ are all placed on the straight line.

$$( \begin{matrix}X \\ Y\end{matrix} ) = ( 1 - α ) ( \begin{matrix}x \\ y\end{matrix} ) + α ( \begin{matrix}u \\ v\end{matrix} ) … α = \frac{{d}_{pint}}{d} \qquad ( 11 )$$

Where (X, Y) indicate coordinates of the point where the beam passing through the point (u, v) on the u plane and the point (x, y) on the x plane intersects with the focusing plane in terms of the camera coordinates. To obtain an image where z=dₚᵢₙₜ is focused, the LF data may be integrated with regard to u and v in a direction of a tangent vector (1−α, 1−α, −α, −α) of the plane represented by Expression (11). When a distance between the x plane 402 and the LF camera is set as K, and an F-number of the main lens 212 of the LF camera is set as F, the LF camera obtains a light field in the range of [−K/F, K/F] on the x plane 402 from FIG. 10. Therefore, the image I (X, Y) formed at the position of z=dₚᵢₙₜ is represented by the following expression.

$$I ( X , Y ) = {\int }_{- \frac{K}{F}}^{\frac{K}{F}} {\int }_{- \frac{K}{F}}^{\frac{K}{F}} L ( u , v , \frac{1}{1 - α} X - \frac{α}{1 - α} u , \frac{1}{1 - α} Y - \frac{α}{1 - α} v ) d u d v \qquad ( 12 )$$

The depth of field of the obtained image data can be changed by changing the F-number herein. The image generation unit 1203 obtains the value of α by assigning the inclination of the straight line obtained in S1302 to Expression (11) and obtains I (X, Y) by assigning the derived a and the value of the stitched LF data to Expression (12). It is noted that, since (X, Y) obtained herein are coordinates represented by the camera coordinates of the real space, the image generation unit 1203 outputs data obtained by expanding or reducing this on the basis of a pixel pitch of the image pickup sensor as the image data.

According to the present exemplary embodiment, the obtaining unit 103 functioning as an obtaining unit configured to obtain plural pieces of beam information each indicating the direction and the intensity of the beam incident on the corresponding viewpoint position from the object which are beam information including information related to and respectively correspond to a plurality of different viewpoint positions. The coordinate transform unit 107 and the synthesizing unit 108 function as a synthesizing unit configured to perform the coordinate transform of at least one of the plural pieces of beam information to synthesize the plural pieces of beam information with each other. The parameter calculation unit 106 functions as a derivation unit configured to derivate a transform parameter used in the coordinate transform. The correspondence line detection unit 105 functions as a specifying unit configured to specifying information corresponding to the identical object among the first beam information and the second beam information. The image generation unit 1203 functions as a generation unit configured to generate image data from the synthesized beam information.

The processing performed in the information processing unit 110 according to the present exemplary embodiment has been described above. According to the above-described processing, it is possible to obtain the image data in an arbitrary focusing state by using the stitched LF data. In a case where a technology in a related art is used, to obtain a refocus image in which a plurality of different scenes including the same object are stitched to each other, images refocused at an arbitrary focusing position are to be stitched to each other on a case-by-case basis. For this, complicated processing of calculating the positional information of the respective cameras and the distance information of the object from the respective cameras are to be performed, but if the refocus image is generated by the stitched LF data as described above, it is possible to obtain the wire-range refocus image without performing the above-described processing.

### Other Exemplary Embodiments

It is noted that embodiments of the present invention are not limited to the above-described exemplary embodiments. For example, the distance information of the object may be obtained on the basis of Expression (11) from the inclination of the straight line obtained in S1302 of the second exemplary embodiment. In addition, the distance information is previously obtained with regard to all the pixels within the field angle of the stitched LF data, and the information is used for the refocus processing, so that the speed of the processing can be increased. Furthermore, the method of generating the refocus image is not limited to the method according to the second exemplary embodiment, and a method of performing Fourier transform of the four-dimensional LF data and cutting out the two-dimensional data corresponding to the focusing plane from the resultant data to perform inversed Fourier transform may be employed.

According to the above-described exemplary embodiments, stitching of the LF data is performed, but the present invention may be applied to other beam information defined in the above-described exemplary embodiments so long as the information indicates the direction and the intensity of the beam. In addition, according to the above-described exemplary embodiments, the corresponding straight line in the LF data is detected to obtain the parameter of the coordinate transform, but any other methods may be employed so long as the method defines the correspondence relationship between the two pieces of LF data. For example, matching of the LF data to each other is performed while the coordinate transform parameter is changed, and the coordinate transform parameter at which the matching error is the smallest may be used.

The configuration of the image processing apparatus according to the present invention is not limited to the above-described exemplary embodiments, and a configuration in which the functions of the respective blocks are divided into a plurality of blocks or a configuration in which a block including functions of a plurality of blocks is included may be employed. It is noted that, for example, the present invention can adopt embodiments as a system, an apparatus, a method, a program, a storage medium, or the like. In addition, the present invention may be applied to a system constituted by a plurality of devices or applied to an apparatus constituted by a single device. That is, the above-described exemplary embodiments are applied to the camera provided with the two plenoptic image pickup units, but the exemplary embodiments may be applied to any mode so long as the information processing apparatus can perform the stitch processing of the LF data described above. For example, the exemplary embodiments may be applied to the information processing apparatus in which the LF data previously obtained by using the two plenoptic cameras are obtained via a network, and the pieces of LF data are stitched to each other.

Moreover, the present invention can also be realized by supplying a storage medium storing a program code of software that realizes the functions of the above-described exemplary embodiments (for example, the steps illustrated in the above-described flowcharts) to a system or an apparatus. In this case, a computer (or a CPU or an MPU) of the system or the apparatus reads out and executes the program code stored in the storage medium in a computer-readable manner, so that the functions of the above-described exemplary embodiments are realized. Furthermore, the program may be executed by a single computer or executed by a plurality of computers in conjunction with each other.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-262756, filed Dec. 19, 2013, which is hereby incorporated by reference herein in its entirety.

What is claimed is:

1. An information processing apparatus comprising:
an obtaining unit configured to obtain first beam information and second beam information, the first beam information indicating a direction and an intensity of a first beam from an object as seen from a first viewpoint and defined by a first coordinate system, and the second beam information indicating a direction and an intensity of a second beam from the object as seen from a second viewpoint different from the first viewpoint and defined by a second coordinate system different from the first coordinate system; and
a synthesizing unit configured to synthesize the first beam information and the second beam information with each other after performing a coordinate transform of at least one of the first beam information and the second beam information.

2. The information processing apparatus according to claim 1, wherein the synthesizing unit matches coordinate systems of the first beam information and the second beam information with each other by performing the coordinate transform of at least one of the first beam information and the second beam information and synthesizes the first beam information and the second beam information having the matched coordinate systems with each other.

3. The information processing apparatus according to claim 2, further comprising:
a derivation unit configured to derive a transform parameter used for the coordinate transform,
wherein the synthesizing unit performs the coordinate transform on the basis of the transform parameter derived by the derivation unit.

4. The information processing apparatus according to claim 3, further comprising:
a specifying unit configured to specify information corresponding to an identical object among the first beam information and the second beam information,
wherein the derivation unit derives the transform parameter on the basis of the specified information corresponding to the identical object.

5. The information processing apparatus according to claim 4, wherein the specifying unit specifies the information corresponding to the identical object in the first coordinate system and the second coordinate system by detecting a straight line corresponding to the identical object.

6. The information processing apparatus according to claim 5, wherein the specifying unit performs the Radon transform of the first beam information and the second beam information and detects the corresponding straight line on the basis of a result of the Radon transform.

7. The information processing apparatus according to claim 1, further comprising:
an interpolation unit configured to perform interpolation processing on one of the first beam information and the second beam information on which the coordinate transform has been performed,
wherein the synthesizing unit synthesizes beam information on which the interpolation processing has been performed.

8. The information processing apparatus according to claim 1, further comprising:
a generation unit configured to generate image data from the synthesized beam information.

9. The information processing apparatus according to claim 8, wherein the generation unit generates the image data by integrating the beam information synthesized by the synthesizing unit in a direction based on a straight line corresponding to a predetermined object.

10. The information processing apparatus according to claim 1, wherein the first beam information and the second beam information include information indicating coordinates of points in two planes through which the beam passes.

11. The information processing apparatus according to claim 1, wherein the first beam information and the second beam information include information indicating coordinates of the beam in a predetermined plane through which the beam passes and information indicating a direction of the beam.

12. An information processing method comprising:
obtaining first beam information and second beam information, the first beam information indicating a direction and an intensity of a first beam from an object as seen from a first viewpoint and defined by a first coordinate system, and the second beam information indicating a direction and an intensity of a second beam from the object as seen from a second viewpoint different from the first viewpoint and defined by a second coordinate system different from the first coordinate system; and
synthesizing the first beam information and the second beam information with each other after performing a coordinate transform of at least one of the first beam information and the second beam information.

13. A non-transitory computer readable storage medium storing a program for causing a computer to perform the information processing method according to claim 12.

14. An information processing method comprising:
obtaining plural pieces of beam information each indicating a direction and an intensity of beam incident from an object included in a corresponding scene which respectively correspond to a plurality of different scenes including a same object; and
synthesizing the plural pieces of beam information with each other by performing a coordinate transform of at least one of the plural pieces of beam information.
